(19) United States
(12) Patent Application Publication
(10) Pub. No.: US 2026/0011160 A1
(43) Pub. Date: Jan. 8, 2026

(54) METHOD AND DEVICE FOR PROCESSING SLIDE IMAGE

(71) Applicant: Vieworks Co., Ltd., Anyang-si (KR)

(72) Inventor: Mingyu JIN, Seoul (KR)

(21) Appl. No.: 19/258,171

(22) Filed: Jul. 2, 2025

(30) Foreign Application Priority Data
Jul. 3, 2024 (KR) 10-2024-0087489

(51) Int. Cl. G06V 20/69; G06V 10/25; G06V 10/26

(52) U.S. Cl. CPC G06V 20/695; G06V 10/25; G06V 10/267; G06V 10/273

(57) ABSTRACT

According to one embodiment, a slide image processing device includes: an image input unit receiving a slide image of a slide on which a sample is mounted; an object identification unit identifying an object region included in the slide image; and a rearrangement unit reducing a size of the slide image by rearranging the object region in the slide image.

### CROSS-REFERENCE TO RELATED APPLICATIONS

This application claims priority to and the benefit of Korean Patent Application No. 10-2024-0087489 filed in the Korean Intellectual Property Office on Jul. 3, 2024, the entire contents of which are incorporated herein by reference.

### TECHNICAL FIELD

The present invention relates to a technology for processing a slide image. More particularly, the present invention relates to a method and a device for processing a slide image that reduces a storage space and facilitates an easy search.

### BACKGROUND ART

A scanning device used in conjunction with a microscope is known. As an example, a slide scanner is a device that can automatically scan a slide, on which tissue samples to be inspected are put, to store, observe and/or analyze images, and is used to obtain images of tissue samples in various preclinical experiments or pathology tests.

The slide scanner photographs the tissue of the slide by enlargement to several dozens to several hundreds of times, and thus can photograph the image of the tissue with a small field of view (FOV) and stitch the photographed image to generate a digital slide image (a whole slide image (WSI)).

The whole slide image (WSI) obtained via the slide scanner includes a very large number of pixels. As an example, when slide scanning is performed at a magnification of 40 times, 4×4 pixels may represent 1 μm² and the resolution of the image may be 0.25 μm/pixel. When scanning is performed with the slide scanner at a magnification of 40 times for a sample having a size of 5 cm×2 cm, (5×10×1000×4)×(2×10×1000×4)=200 k×80 k=16×10⁹ pixels are required. A very large storage space is thus required to store one whole slide image.

### SUMMARY OF THE INVENTION

In the case of a slide image for pathology examination, the compression for the image requires using a lossless compression or high-quality compression scheme due to the characteristics of the image and thus has a low compression ratio. Therefore, even if a whole slide image is compressed, a very large storage space is required, and a lot of resources are required during image processing or transmission.

When the slide image is displayed on a screen at a high magnification, a number of operations (e.g., a plurality of scroll operations) may be required to move the diagnostic point when changing a diagnostic point from a particular point of a sample to another point. In particular, when there is a blank between cells or tissues in the whole slide image, it is necessary to pass a meaningless blank portion, thereby requiring more time for diagnosis.

In order to solve this problem, the present invention has been made in an effort to provide a method and a device for processing a whole slide image, which maintain information of a whole slide image and process the whole slide image to reduce a capacity of the whole slide image by maintaining a tile of a meaningful region of interest such as a cell or tissue in a slide image and removing a tile of a meaningless region of no interest such as a blank.

An exemplary embodiment of the present invention provides a slide image processing device including: an image input unit receiving a slide image of a slide on which a sample is mounted; an object identification unit identifying an object region included in the slide image; and a rearrangement unit reducing a size of the slide image by rearranging the object region in the slide image.

In an exemplary embodiment, the slide image processing device may further include a region-of-interest setting unit setting a region of interest in the slide image, and the object identification unit may identify the object region according to the region of interest.

In an exemplary embodiment, the slide image may be partitioned into a plurality of tiles having a predetermined size, and the region of interest may be set with respect to the tile.

In an exemplary embodiment, the object identification unit may group the tiles corresponding to the region of interest adjacent in a vertical or horizontal direction, and identify the grouped tiles as one object region.

In an exemplary embodiment, the slide image may be one of a whole slide image, a thumbnail image of the slide, and a low-resolution image generated by lowering a resolution of the whole slide image.

In an exemplary embodiment, the rearrangement unit may include a movable region determination unit determining a movable region of the object region with respect to a reference position of the slide image, and a movement arrangement unit moving and arranging the object region according to the movable region.

In an exemplary embodiment, the reference position may be a reference point for a predetermined position of the slide image or a reference line according to a first direction or a second direction.

In an exemplary embodiment, the movable region determination unit may determine the movable region of the object region toward the reference position, and maintain a relative arrangement to other objects or maintain a spacing to be distinguished from other objects.

In an exemplary embodiment, the movable region determination unit may determine a movable region of the object regions in order close to the reference position, the movement arrangement unit may move the object regions by the movable region, and the determination of the movable region and the movement of the object regions may be repeated until it is determined that there is no more movable region with respect to the object regions.

In an exemplary embodiment, the rearrangement unit may determine and move a movable region of any one of the object regions, and then determine and move a movable region of the other one object region, in order close to the reference position.

Further, another exemplary embodiment of the present invention provides a slide image processing method including: receiving, by an image input unit, a slide image of a slide on which a sample is mounted; identifying, by an object identification unit, an object region included in the slide image; and rearranging, by a rearrangement unit, the object region in the slide image.

According to exemplary embodiments of the present invention, it is possible to reduce the capacity of the slide image by maintaining a meaningful region of interest in the slide image and removing a meaningless region of no interest or a blank, thereby reducing a storage space for storing the slide image or a resource for transmitting the whole slide image.

In addition, according to the present invention, when there are a plurality of regions of interest such as a tissue or a sample included in the slide image, a relative positional relationship of the plurality of regions of interest may be maintained, thereby not causing confusion in the analysis of the whole slide image. If the relative positional relationship of the plurality of regions of interest is not maintained, a problem may arise in which it is difficult to determine which cells or tissues are included in a particular region of interest.

In addition, according to the present invention, in the analysis of the slide image, the time required for the analysis of the whole slide image can be shortened as the time for skipping a blank portion is reduced by reducing the blank portion.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a configuration of a slide image processing device according to an exemplary embodiment of the present invention.

FIG. 2 is a diagram illustrating an example of setting a region of interest in an input slide image in the slide image processing device according to an exemplary embodiment of the present invention.

FIGS. 3 and 4 are diagrams exemplarily illustrating determination of a movable region of an object in the slide image processing device according to an exemplary embodiment of the present invention.

FIG. 5 is a diagram illustrating that an object is moved in the slide image according to the movable region in the slide image processing device according to an exemplary embodiment of the present invention.

FIG. 6 is a diagram exemplarily illustrating a final slide image in which movement of an object is completed in the slide image processing device according to an exemplary embodiment of the present invention.

FIG. 7 is a diagram exemplarily illustrating the determination of the movable region and the movement of the object are sequentially processed for each object in the slide image processing device according to an exemplary embodiment of the present invention.

FIG. 8 is a flowchart illustrating a slide image processing method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The present invention may have various transformations and various exemplary embodiments and specific exemplary embodiments will be illustrated in the drawings and described in detail in the detailed description. However, this does not limit the present invention within specific exemplary embodiments, and it should be understood that the present invention covers all the modifications, equivalents and replacements within the technical idea and technical scope of the present invention. In describing the present invention, a detailed description of related known technologies will be omitted if it is determined that they make the gist of the present invention unclear.

Terms including first, second, and the like are used for describing various components, but the components are not limited by the terms. The terms are used only to discriminate one component from another component.

Terms used in the present invention are used only to describe specific exemplary embodiments, and are not intended to limit the present invention. Terms used in the present invention adopt general terms which are currently widely used as much as possible by considering functions in the present invention, but the terms may be changed depending on an intention of those skilled in the art, a precedent, or emergence of new technology, etc. Further, in a specific case, a term which an applicant arbitrarily selects is present and in this case, a meaning of the term will be disclosed in detail in a corresponding description part of the invention. Accordingly, a term used in the present invention should be defined based on not just a name of the term but a meaning of the term and contents throughout the present invention.

A singular form includes a plural form if there is no clearly opposite meaning in the context. In the present invention, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Hereinafter, the exemplary embodiments of the present invention will be described in detail with reference to the accompanying drawings, in which like reference numerals refer to like or corresponding elements and a duplicated description thereof will be omitted when the exemplary embodiments are described with reference to the drawings.

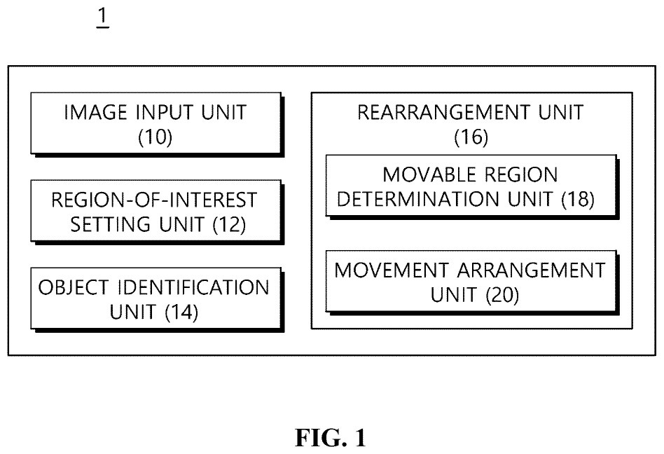

FIG. 1 is a block diagram illustrating a configuration of a slide image processing device according to an exemplary embodiment of the present invention.

The slide image processing device 1 according to an exemplary embodiment of the present invention includes an image input unit 10, a region-of-interest setting unit 12, an object identification unit 14, and a rearrangement unit 16.

The image input unit 10 receives a slide image scanned and generated by a slide scanner. The slide image may be a whole slide image (WSI) or a part of the whole slide image. In addition, the slide image may be an original of the whole slide image, or may be a thumbnail image corresponding to the whole slide image or a low-resolution image of the original of the whole slide image.

The region-of-interest setting unit 12 sets a region of interest (ROI) in the slide image.

The object identification unit 14 groups regions of interest set in the region-of-interest setting unit 12 and identifies the grouped regions of interest as one object. There may be a plurality of objects identified in the slide image. In addition, in the exemplary embodiment of the present invention, it may be possible to directly identify an object region in the slide image by the object identification unit 14 without setting the region of interest by the region-of-interest setting unit 12.

The rearrangement unit 16 identifies, for each of the identified objects, a movable region considering a reference position and other objects, and moves the identified objects to rearrange the objects in the slide image. A modified slide image in which the rearrangement of the objects is completed may be output or stored externally. In an exemplary embodiment, the rearrangement unit 16 may include a movable region determination unit 18 that determines a movable region in which the identified object may be moved, and a movement arrangement unit 20 that moves and rearranges the object in the slide image according to the movable region determined by the movable region determination unit 16.

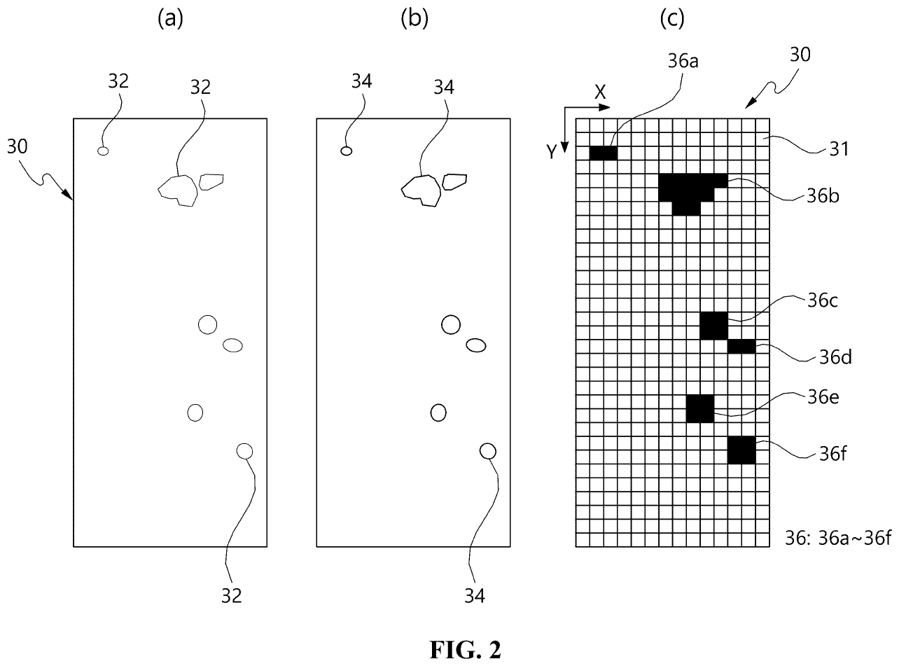

FIG. 2 is a diagram illustrating an example of setting a region of interest in an input slide image in the slide image processing device according to an exemplary embodiment of the present invention.

Part (a) of FIG. 2 exemplarily illustrates a slide image 30, and an image 32 of a cell and the like included in the slide image 30 is illustrated. Part (b) of FIG. 2 illustrates that a region of interest 34 in the slide image 30 is represented by a circle or a polygon, and part (c) of FIG. 2 illustrates an object 36 identified according to the region of interest 34.

The region of interest 34 may include a region that includes information for inspection or examination in a sample placed on a slide, such as a cell, tissue, or organ. In an exemplary embodiment, the region of interest 34 may be a region where an object is determined to be present in the slide image. In the present invention, since the setting of the region of interest 34 is to exclude an empty region without an object or an unnecessary region in which information for inspection or examination is not included in the slide image 30, the region of interest 34 may be variously set as necessary.

The region-of-interest setting unit 12 may divide the slide image 30 into a plurality of tiles 31, determine whether the plurality of tile 31 corresponds to the region of interest, and set the region of interest. One tile 31 may include M×N pixels (M and N are natural numbers), such as 1×1 pixel, 2×2 pixels, 4×4 pixels, 4×8 pixels, 8×8 pixels, 8×16 pixels, or 16×16 pixels. One region of interest 34 includes at least one tile 31, and it may also be possible that a plurality of tiles 31 are grouped to constitute one region of interest 34.

The setting of the region of interest may be performed directly for the slide image. However, since the slide image has a very large number of pixels, it may take a considerable processing time to directly process the slide image and set the region of interest. In an exemplary embodiment, the region-of-interest setting unit 12 may search for the region of interest by targeting a thumbnail image for a slide or a low-resolution image generated by lowering a resolution of the slide image, and map the region of interest in the thumbnail or low-resolution image to the slide image. In an exemplary embodiment, the thumbnail image may be obtained by photographing a slide on which a sample is mounted using a separate camera. The low-resolution image may be obtained by down-sampling the slide image. For example, the region-of-interest setting unit 12 searches for the region of interest by using 1×1 pixel as one tile in a low-resolution image generated by down-sampling 16×16 pixels of the slide image into one pixel. When the region of interest is set in the low-resolution image, tiles in the slide image corresponding to tiles included in the region of interest in the low resolution images may be designated as the region of interest.

In addition, in the exemplary embodiment of the present invention, the object identification unit 14 and the rearrangement unit 16 may perform identification and movement of the object with respect to the thumbnail image or the low-resolution image, and apply the performed result to the tile of the slide image corresponding to the tile in the thumbnail image or the low-resolution image. As a result, the slide image 30 in FIG. 2 may be understood to be any one of an original image, the thumbnail image, or the low-resolution image.

In an exemplary embodiment, the region-of-interest setting unit 12 may search for the region of interest in the slide image, the thumbnail image, or the low-resolution image by applying a technique such as a signal filter based on a grayscale of a tile, a color filter based on hue or multi-channel thresholding, a morphology filter such as an erosion or dilation operation, or contrast limited adaptive histogram equalization (CLAHE).

The object identification unit 14 groups regions of interest 34 set in the region-of-interest setting unit 12 and identifies the grouped regions of interest as one object. In one embodiment, a plurality of tiles for a plurality of regions of interest connected in a vertical or horizontal direction may be identified as one object 36. In part (c) of FIG. 2, first to sixth objects 36a to 36f are exemplarily illustrated.

In an exemplary embodiment, the object identification unit 14 may identify an object by applying a depth first search (DFS) algorithm based on a predetermined position of the slide image. For example, with respect to the slide image 30 illustrated in part (c) of FIG. 2, object identification may be performed while moving in an X-axis direction and a Y-axis direction at a top left corner (0, 0).

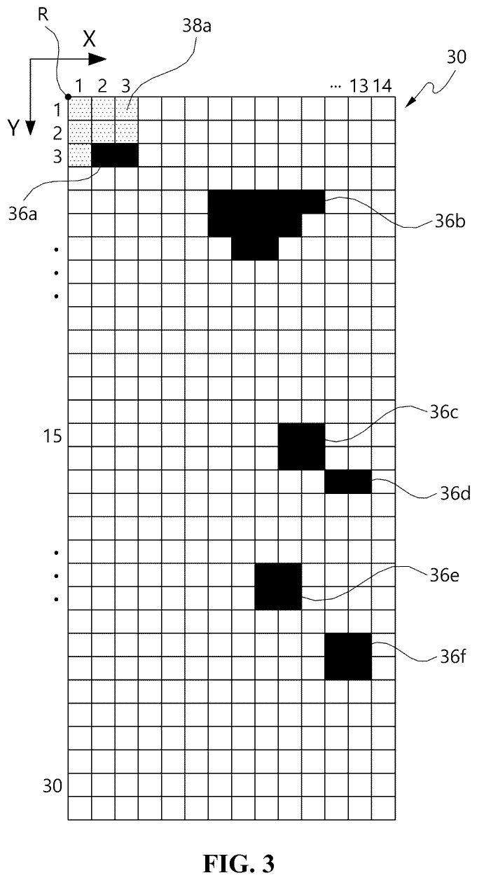

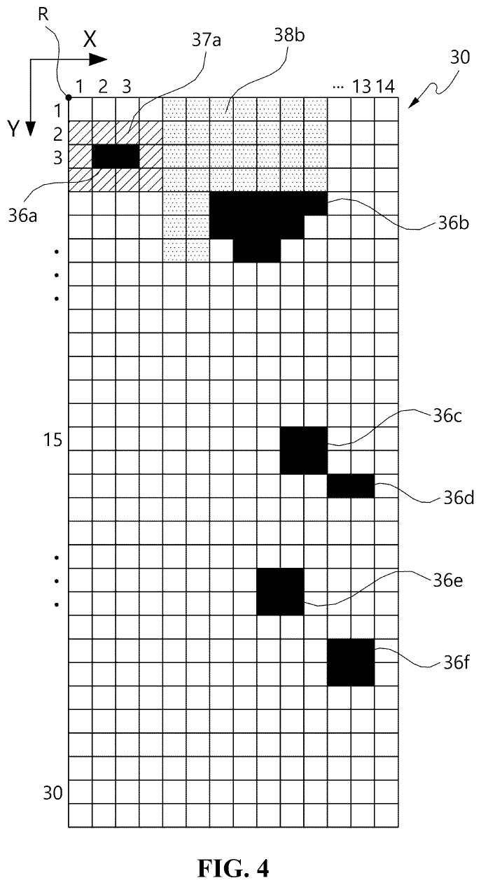

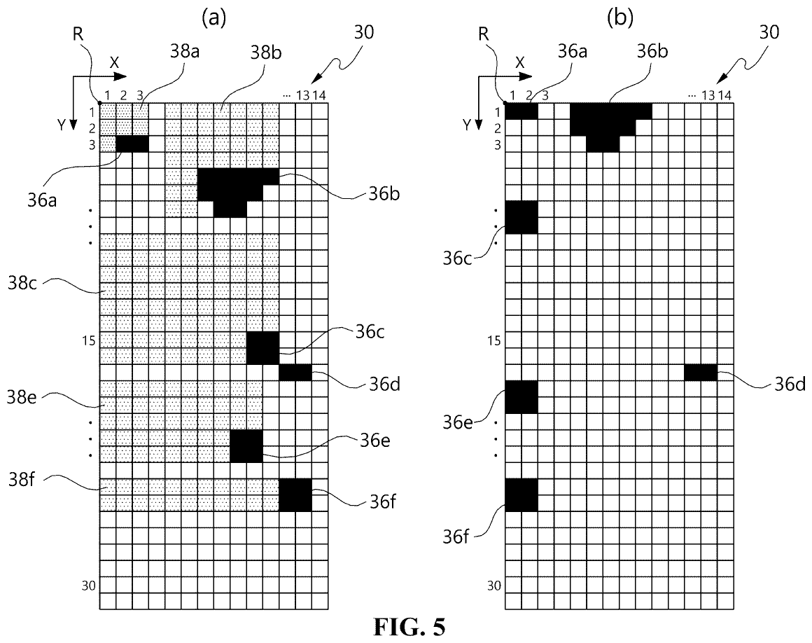

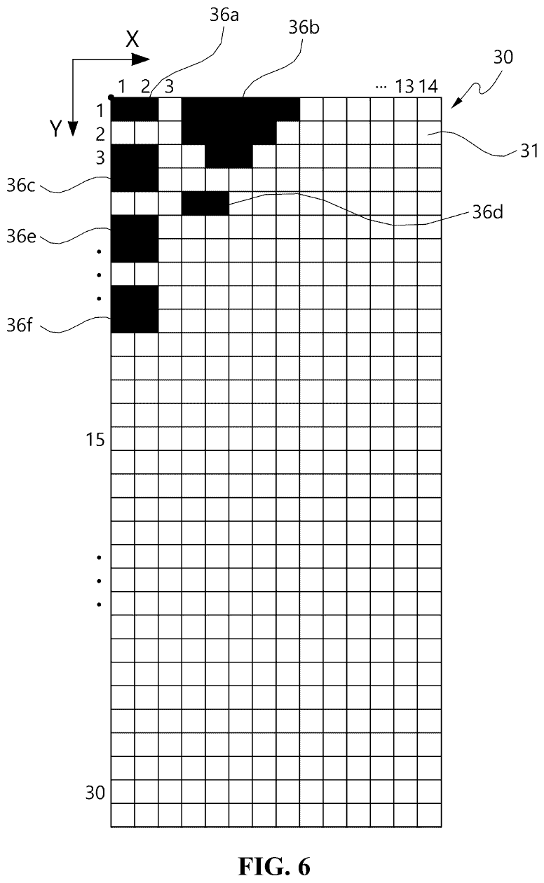

FIGS. 3 and 4 are diagrams exemplarily illustrating determination of a movable region of an object in the slide image processing device according to an exemplary embodiment of the present invention. FIG. 5 is a diagram illustrating that an object is moved in the slide image according to the movable region in the slide image processing device according to an exemplary embodiment of the present invention. Further, FIG. 6 is a diagram exemplarily illustrating a final slide image in which movement of an object is completed in the slide image processing device according to an exemplary embodiment of the present invention.

In the present invention, the movement of the object 36 included in the slide image 30 may be regulated such that a blank portion is minimized while maintaining a relative position with the other object 36 with respect to a reference position R. The reference position R may be a reference point or a reference line. In an exemplary embodiment, the reference position R may be set to a leftmost top point (0, 0) in the slide image 30. In this case, the object included in the slide image 30 may be moved toward the reference point of (0, 0). In addition, in the exemplary embodiment of the present invention, the reference position R may be an uppermost horizontal line or a left or right vertical line. For example, when the reference position R is the uppermost horizontal line, the object included in the slide image 30 will be moved upward toward the X-axis where a Y-coordinate is 0. Hereinafter, the reference position R will be described as the reference point of (0, 0).

In one embodiment, the movement of the object 36 in the slide image 30 by the rearrangement unit 16 may be accomplished by the rearrangement unit 16 determining a movable region for each of the objects 36 included in the slide image 30, moving the position in the slide image 30 by the movable region for each object 36, and repeating the determination of the movable region for each object 36 and the movement of the objects 36 until there is no more movable region.

Referring to FIGS. 3 and 4, the rearrangement unit 16 determines the movable region for each of the objects 36 in order of the X-axis direction and the Y-axis direction with respect to the reference position R. When the movable region for any one object 36 is determined, regions in which other objects 36 are located may be set as non-movable regions. The objects 36 may have a spacing of at least one row or column of tiles such that the objects 36 may be distinguished from each other. To this end, when the movable region for any one object 36 is determined, tiles occupied by other objects 36 and tiles adjacent thereto may be set as a non-movable region.

Referring to FIG. 3, in the case of a first object 36a, it is determined that a first movable region 38a is located in (2, 3) and (3, 3) tiles and is movable by two tiles in an upper direction and by one tile in a left direction.

Referring to FIG. 4, a second movable region 38b of a second object 36b is determined. In this case, other objects 36a, 36c, 36d, 36e, and 36f other than the second object 36b and surrounding regions thereof may be designated as the non-movable regions when determining the movable region of the second object 36b (in FIG. 4, for example, a non-movable region 37a is displayed around the first object 36a and third to sixth objects 36a, 36d, 36e, and 36f are not displayed). That is, when determining the second movable region 38b of the second object 36b, the non-movable region may not be passed. In FIG. 4, in the case of the second object 36b, the second movable region 38b capable of moving by four tiles in the upper direction and by two tiles in the left direction appears.

Referring to FIGS. 3 and 4, when determining the movable region described above, the movable region may be determined by considering both the upper direction (Y-axis direction) and the left direction (X-axis direction) with respect to the reference position R. Then, when it is determined that movement in either direction is impossible, a movable region in which further movement is possible in the upper direction or the left direction may be further determined. However, in the exemplary embodiment of the present invention, it may be possible to first determine the movable region in any one of the upper direction (Y-axis direction) and the left direction (X-axis direction) to move the object, and then determine the movable region in the other direction to move the object. That is, in the present invention, a movable region of an object may be determined in various ways as long as a meaningful region of interest may be maintained in the slide image, and a non-meaningful region of interest or a blank may be removed.

Part (a) of FIG. 5 illustrates the first to sixth movable regions 38a to 38f with respect to the first to sixth objects 36a to 36f, and part (b) of FIG. 5 illustrates a result of moving the first to sixth objects 36a to 36f. Referring to part (a) and part (b) of FIG. 5, in the case of the fourth object 36d, it is determined that there is no fourth movable region due to the third object 36c. Further, moving the object may be understood as moving a value of a tile on which the object is located to a value of the tile after the movement.

Referring to part (b) of FIG. 5, the first to sixth movable regions 38a to 38f for the first to sixth objects 36a to 36f are determined, and results 36a to 36f of moving the first to sixth objects 36a to 36f are illustrated. However, in a state of part (b) of FIG. 5, in the case of the first object 36a, there is no further movable region, but in the case of the second object 36b, it is possible to move by one tile to the left. Further, in the case of the third to sixth objects 36c to 36f there is an additional movable region.

The rearrangement unit 16 may repeat the process described in FIGS. 3 to 5 to complete the rearrangement of the object in the slide image 30 when all of the objects 36 in the slide image 20 are no longer able to move in a state of FIG. 6.

Comparing FIGS. 3 and 6, it is possible to reduce a size of the slide image 30 by removing a non-interest area or a blank in the slide image 30 as the determination of the movable region for the objects 36 in the rearrangement unit 16 and the movement of the objects 36 are repeated. That is, in FIG. 3, a memory of 13×25 tiles is required for the slide image 30, but in FIG. 6, a memory of 8×10 tiles is required.

In another embodiment, the movement of the object 36 in the slide image 30 by the rearrangement unit 16 may be performed in such a way that the rearrangement unit 16 completes the determination and movement of the movable region sequentially for each object.

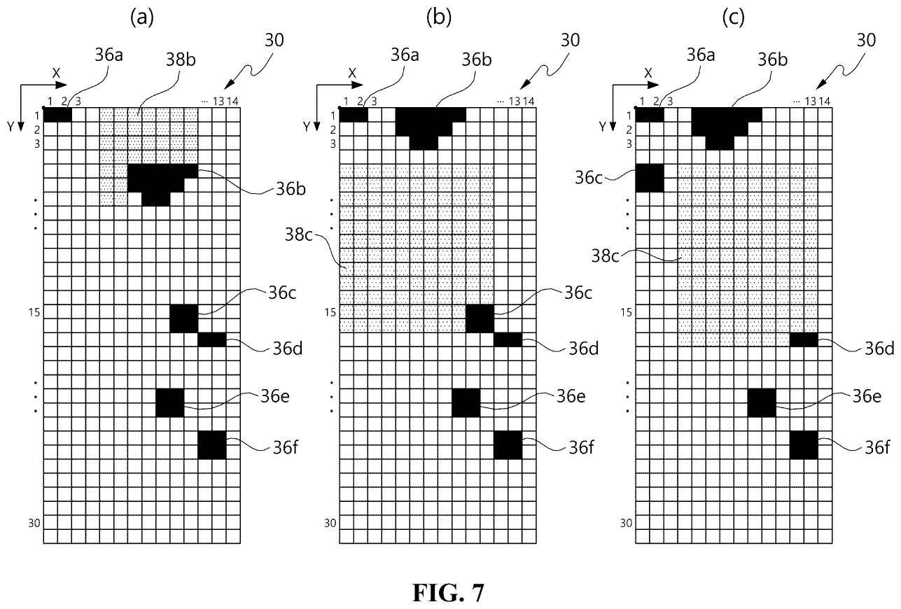

FIG. 7 is a diagram exemplarily illustrating the determination of the movable region and the movement of the object are sequentially processed for each object in the slide image processing device according to an exemplary embodiment of the present invention.

As illustrated in FIG. 3, the first movable region 38a is determined with respect to the first object 36a, and the first object 36a is moved as illustrated in part (a) of FIG. 7. Next, the second movable region 38b for the second object 36b is determined, and the second object 36b is moved by the second movable region 38b (part (b) of FIG. 7). Next, the third movable region 38c for the third object 36c is determined, and the third object 36c is moved by the third movable region 38c (part (c) of FIG. 7). By the same scheme, a process of determining and moving the movable region for each of the fourth to sixth objects 36d to 36f is repeated. In part (c) of FIG. 7, the fourth movable region 38d for the fourth object 36d is illustrated.

A result according to a moving process of the object with reference to FIG. 7 may be partially different from that of FIG. 6, but an effect of reducing the size of the slide image 30 by removing an unnecessary region from the slide image 30 and moving tiles corresponding to the region of interest is not significantly different.

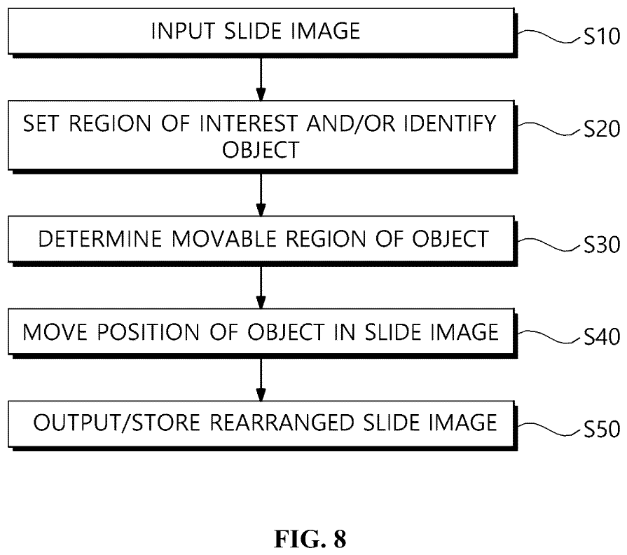

FIG. 8 is a flowchart illustrating a slide image processing method according to an exemplary embodiment of the present invention.

A slide image is input to the image input unit 10 of the slide image processing device 1 (S10).

The slide image may be a whole slide image (WSI) or a part of the whole slide image. In addition, the slide image may be an original of the whole slide image, or may be a thumbnail image corresponding to the whole slide image or a low-resolution image of the original of the whole slide image.

Setting of the region of interest and/or object identification are/is performed for the input slide image (S20). The region-of-interest setting unit 12 may set a region including information for inspection or examination in the slide image as the region of interest. In an exemplary embodiment, the setting of the region of interest may be made in units of tiles constituted by a predetermined number of pixels. The object identification unit 14 may identify the object in the slide image. In an exemplary embodiment, based on the region of interest set by the region-of-interest setting unit 12, the object identification unit may group the regions of interest connected up and down or left and right, and identify the grouped regions of interest as one object.

The movable region determination unit 18 of the rearrangement unit 16 determines movable regions of the objects identified in the slide image (S30), and the movement arrangement unit 20 moves a position of each object in the slide image by the movable region for each object (S40).

In an exemplary embodiment, the movement of the object in the slide image by the rearrangement unit 16 may be accomplished by the rearrangement unit 16 determining a movable region for each of the objects included in the slide image, moving the position in the slide image by the movable region for each object, and repeating the determination of the movable region for each object and the movement of the objects until there is no more movable region.

In an exemplary embodiment, the movement of the object in the slide image by the rearrangement unit 16 may be made in a scheme of completing movable region determination and movement sequentially for each object in a scheme in which the rearrangement unit 16 determines the movable region for a first object close to a reference position, moves the first object, determines a movable region for a second object next close to the reference position, and moves the second object.

The slide image in which the object is rearranged by completing the movement of the object in the slide image may be output to the outside of the slide image processing device 1 or stored in a separate storage medium (S50).

A device according to exemplary embodiments of the present invention may include a processor, a memory for storing and executing program data, a permanent storage such as a disk drive, a communication port for communicating with an external device, a user interface device such as a touch panel, a key, a button, and the like. Methods implemented as software modules or algorithms may be stored on a computer-readable recording medium as computer-readable codes or program instructions executable on the processor. Here, computer-readable recording media include magnetic storage media (e.g., read-only memory (ROM), random-access memory (RAM), floppy disks, hard disks, etc.) and optical reading media (e.g., CD-ROM, DVD: Digital Versatile Disc). The computer readable recording media may be stored and executed as codes which may be distributed in the computer system connected through a network and read by a computer in a distribution method. The media are readable by the computer, and may be stored in the memory and executed by the processor.

Exemplary embodiments of the present invention may be represented by functional block configurations and various processing steps. These functional blocks may be implemented as various numbers of hardware and/or software components that perform specific functions. For example, exemplary embodiments may employ integrated circuit components, such as memory, processing, logic, look-up tables, etc., that may perform various functions under the control of one or more microprocessors or other control devices. The components of the present invention may be implemented as software programming or software elements, and similarly, exemplary embodiments may include various algorithms implemented as combinations of data structures, processes, routines or other programming constructs to be implemented in a programming or scripting language such as C, C++, Java, assembler, Python, etc. Functional aspects may be implemented as algorithms executed on one or more processors. Additionally, the exemplary embodiments may employ conventional techniques for electronic environmental configuration, signal processing, and/or data processing. Terms such as “mechanism”, “element”, “means”, and “component” may be used broadly and are not limited to mechanical and physical components. The above term may include the meaning of a series of software processes (routines) in connection with a processor, etc.

Specific executions described in the exemplary embodiment are exemplary embodiments and the scope of the exemplary embodiment is not limited even by any method. For brevity of the specification, descriptions of conventional electronic configurations, control systems, software, and other functional aspects of the systems may be omitted. Further, connection or connection members of lines among components exemplarily represent functions connections and/or physical or circuitry connections and may be represented as various functional connections, physical connections, or circuitry connections which are replaceable or added in an actual device. Further, unless otherwise specified, such as “essential”, “important”, etc., the connections may not be components particularly required for application of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A slide image processing device comprising:
an image input unit receiving a slide image of a slide on which a sample is mounted;
an object identification unit identifying an object region included in the slide image; and
a rearrangement unit reducing a size of the slide image by rearranging the object region in the slide image.

2. The slide image processing device of claim 1, further comprising:
a region-of-interest setting unit setting a region of interest in the slide image,
wherein the object identification unit identifies the object region according to the region of interest.

3. The slide image processing device of claim 2, wherein the slide image is partitioned into a plurality of tiles having a predetermined size, and the region of interest is set with respect to the tile.

4. The slide image processing device of claim 3, wherein the object identification unit groups the tiles corresponding to the region of interest adjacent in a vertical or horizontal direction, and identifies the grouped tiles as one object region.

5. The slide image processing device of claim 1, wherein the slide image is one of a whole slide image, a thumbnail image of the slide, and a low-resolution image generated by lowering a resolution of the whole slide image.

6. The slide image processing device of claim 1, wherein the rearrangement unit includes a movable region determination unit determining a movable region of the object region with respect to a reference position of the slide image, and a movement arrangement unit moving and arranging the object region according to the movable region.

7. The slide image processing device of claim 6, wherein the reference position is a reference point for a predetermined position of the slide image or a reference line according to a first direction or a second direction.

8. The slide image processing device of claim 6, wherein the movable region determination unit determines the movable region of the object region toward the reference position, and maintains a relative arrangement to other objects or maintains a spacing to be distinguished from other objects.

9. The slide image processing device of claim 6, wherein the movable region determination unit determines a movable region of the object regions in order close to the reference position, the movement arrangement unit moves the object regions by the movable region, and the determination of the movable region and the movement of the object regions are repeated until it is determined that there is no more movable region with respect to the object regions.

10. The slide image processing device of claim 6, wherein the rearrangement unit determines and moves a movable region of any one of the object regions, and then determines and moves a movable region of the other one object region, in order close to the reference position.

11. A slide image processing method comprising:
receiving, by an image input unit, a slide image of a slide on which a sample is mounted;
identifying, by an object identification unit, an object region included in the slide image; and
rearranging, by a rearrangement unit, the object region in the slide image.

12. The slide image processing method of claim 11, further comprising:
setting, by a region-of-interest setting unit, a region of interest in the slide image,
in the identifying of the object region, the object identification unit identifies the object region according to the region of interest.

13. The slide image processing method of claim 12, wherein the slide image is partitioned into a plurality of tiles having a predetermined size, and the region of interest is set with respect to the tile.

14. The slide image processing method of claim 13, wherein in the identifying of the object region, the object identification unit groups the tiles corresponding to the region of interest adjacent in a vertical or horizontal direction, and identifies the grouped tiles as one object region.

15. The slide image processing method of claim 11, wherein the slide image is one of a whole slide image, a thumbnail image of the slide, and a low-resolution image generated by lowering a resolution of the whole slide image.

16. The slide image processing method of claim 11, wherein the rearranging includes a movable region determination step of determining a movable region of the object region with respect to a reference position of the slide image, and a movement arrangement step of moving and arranging the object region according to the movable region.

17. The slide image processing method of claim 16, wherein the reference position is a reference point for a predetermined position of the slide image or a reference line according to a first direction or a second direction.

18. The slide image processing method of claim 16, wherein in the movable region determination step, the movable region of the object region toward the reference position is determined, and a relative arrangement to other objects is maintained or a spacing to be distinguished from other objects is maintained.

19. The slide image processing method of claim 16, wherein in the movable region determination step, a movable region of the object regions is determined in order of proximity to the reference position,
in the movement arrangement step, the object regions are moved by the movable region, and
the movable region determination step and the movement arrangement step are repeated until it is determined that there is no more movable region with respect to the object regions.

20. The slide image processing method of claim 16, wherein the rearranging step includes
determining and moving a movable region of any one of the object regions, and
determining and moving a movable region of the other one object region, in order close to the reference position.
